(19) United States
(12) Patent Application Publication
(10) Pub. No.: US 2016/0160864 A1
(43) Pub. Date: Jun. 9, 2016

(54) COOLING SYSTEM FOR AN ENERGY STORAGE SYSTEM AND METHOD OF OPERATING THE SAME

(71) Applicant: General Electric Company, Schenectady, NY (US)

(72) Inventors: Guillaume Becquin, Munich (DE); Mathilde Bieber, Munich (DE); Sebastian Walter Freund, Unterföring (DE)

(21) Appl. No.: 14/561,528

(22) Filed: Dec. 5, 2014

(51) Int. Cl. F04D 25/08; F02C 7/12; F04D 25/16

(52) U.S. Cl. CPC F04D 25/08; F04D 25/16; F02C 7/12

(57) ABSTRACT

An energy storage system includes an intercooler coupled to an axial compressor and a multi-stage radial compressor including a first stage radial compressor and a second stage radial compressor, coupled to the intercooler. The energy storage system further includes a thermal energy storage unit coupled to the multi-stage radial compressor and an air storage unit coupled to the thermal energy storage unit. The energy storage system also includes a turbine coupled to the thermal energy storage unit and a cooling system coupled to the axial compressor and configured to cool air fed to the axial compressor.

### BACKGROUND

The invention relates generally to energy storage systems, and more particularly to cooling systems for cooling air fed to a compressor train of a compressed air energy storage plants.

As population increases, the desire for more electrical power is also increased. Demand for electric power typically varies during the course of a day with afternoon and early evening hours generally being the time of peak demand with later night and very early morning hours generally being the time of lowest demand for electric power. However, power generation systems need to meet both the lowest and highest demand systems for efficiently delivering power at the various demand levels.

One attempt to solve problem associated with various power demand levels is by storing energy generated during off-peak demand hours for use during peak demand hours. Compressed air energy storage plants (CAES) are used for large scale energy storage applications, in adiabatic (ACAES) and non-adiabatic (CAES) variants. The air compressed and stored in containment (for example, a salt cavern) is expanded through a turbine when the stored energy is needed. For such energy storage plants, a round-trip efficiency can be defined as a total energy generated during discharge divided by a total amount energy required by the process to charge-up. As such, there are typically two ways to increase the efficiency of such systems, by either increasing an energy output from an amount of energy stored during discharge or by reducing the required amount of energy to reach a charged state.

In one example, in order to reduce the required amount of energy to reach a charged state of an energy storage plant, an intercooler is used to achieve temperature control of the compressor train. However, the compressor upstream of the intercooler does not benefit from such a reduction in temperature. In another example, a dryer is used to remove humidity before the thermal storage. However, the compressor upstream of the dryer does not benefit from the removal of humidity.

There is a need for an enhanced energy storage system.

### BRIEF DESCRIPTION

In accordance with one exemplary embodiment, an energy storage system is disclosed. The energy storage system includes an intercooler coupled to an axial compressor and a multi-stage radial compressor including a first stage radial compressor and a second stage radial compressor, coupled to the intercooler. The energy storage system further includes a thermal energy storage unit coupled to the multi-stage radial compressor and an air storage unit coupled to the thermal energy storage unit. The energy storage system also includes a turbine coupled to the thermal energy storage unit and a cooling system coupled to the axial compressor and configured to cool air fed to the axial compressor.

In accordance with another exemplary embodiment, a method for operating an energy storage system is disclosed. The method involves cooling air fed to an axial compressor via a cooling system and feeding a first compressed air from the axial compressor to a multi-stage radial compressor including a first stage radial compressor and a second stage radial compressor, via an intercooler. The method further involves feeding a second compressed air from the multi-stage radial compressor to a thermal energy storage unit and storing a thermal energy from the second compressed air in the thermal energy storage unit. The method also involves feeding a cooled compressed air from the thermal energy storage unit to an air storage unit and feeding the cooled compressed air from the air storage unit to the thermal energy storage unit to heat the cooled compressed air using the stored thermal energy. The method also involves feeding a heated compressed air from the thermal energy storage unit to a turbine to expand the heated compressed air and generate an electric power via a generator.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram illustrating an energy storage system having a cooling system operated in accordance with a vapor compression cycle in accordance with an exemplary embodiment;

FIG. 2 is a block diagram illustrating an energy storage system having a cooling system operated in accordance with a vapor absorption cycle in accordance with another exemplary embodiment;

FIG. 3 is a block diagram illustrating an energy storage system having a cooling system operated in accordance with a vapor absorption cycle in accordance with yet another exemplary embodiment;

FIG. 4 is a block diagram illustrating an energy storage system having a cooling system operated in accordance with a vapor absorption cycle in accordance with yet another exemplary embodiment;

FIG. 5 is a block diagram illustrating an energy storage system having a cooling system operated in accordance with a vapor absorption cycle in accordance with yet another exemplary embodiment; and

FIG. 6 is a block diagram illustrating an energy storage system having a cooling system employing a fogging technique in accordance with yet another exemplary embodiment.

### DETAILED DESCRIPTION

In accordance with certain embodiments, an energy storage system is disclosed. The energy storage system includes an intercooler coupled to the axial compressor. A multi-stage radial compressor includes a first stage radial compressor and a second stage radial compressor, coupled to the intercooler. A thermal energy storage unit is coupled to the multi-stage radial compressor and an air storage unit is coupled to the thermal energy storage unit. A turbine is coupled to the thermal energy storage unit and a cooling system is coupled to the axial compressor. The cooling system is configured to cool air fed to the axial compressor. In accordance with certain other embodiments, a method for operating an energy storage system is disclosed.

In accordance with the embodiments discussed herein, a compressor duty of the energy storage system is reduced during a charge phase for the same amount of air stored. It should be noted herein that the compressor duty to achieve a predefined pressure ratio for a predefined mass flow rate of air is dependent on a temperature of the air to be compressed. For lower air temperature, a power requirement of the compressor is substantially lower, while the amount of energy stored is potentially the same. Exemplary active cooling techniques are employed to chill the air before entering the compressor train, thereby decreasing the compressor duty and increasing the overall system efficiency. Inlet chilling of air fed to the axial compressor, ensures that the humidity of the air is converted to a condensate before entering the compressor, thereby eliminating the need of an additional dryer for further drying process.

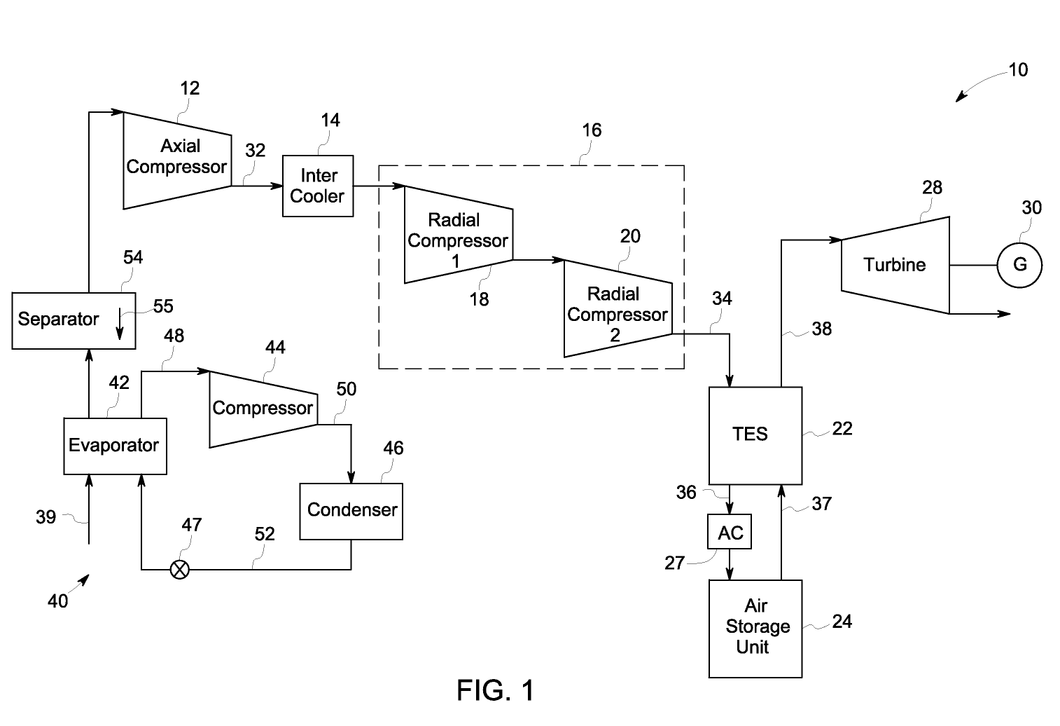

Referring to FIG. 1, a block diagram illustrating an energy storage system 10 is shown in accordance with an exemplary embodiment. The energy storage system 10 includes an axial compressor 12, an intercooler 14 coupled to the axial compressor 12, and a multi-stage radial compressor 16 including a first stage radial compressor 18 and a second stage radial compressor 20, coupled to the intercooler 14. Further, the energy storage system 10 includes a thermal energy storage unit 22 coupled to the multi-stage radial compressor 16 and an air storage unit 24, and a turbine 28 coupled to the thermal energy storage unit 22. Specifically, the thermal energy storage unit 22 is coupled to the air storage unit 24 via an after-cooler 27. A generator 30 is coupled to the turbine 28.

A first compressed air 32 is fed from the axial compressor 12 to the multi-stage radial compressor 16 via the intercooler 14. A second compressed air 34 is fed from the multi-stage radial compressor 16 to the thermal energy storage unit 22. A thermal energy from the second compressed air 34 is retained within the thermal energy storage unit 22 (for example, employing molten salt) for being used at a later stage. Thereafter, a cooled compressed air 36 is fed from the thermal energy storage unit 22 to the air storage unit 24 via the after-cooler 27. Depending on the requirement, the cooled compressed air 37 is fed from the air storage unit 24 to the thermal energy storage unit 22, to heat the cooled compressed air 37, using the stored thermal energy in the energy storage unit 22. A heated compressed air 38 is fed from the thermal energy storage unit 22 to the turbine 28 to expand the heated compressed air 38 and generate an electric power via the generator 30.

A cooling system 40 is coupled to the axial compressor 12 and configured to cool air 39 fed to the axial compressor 12. In the illustrated embodiment, the cooling system 40 includes a vapor compression cycle having an evaporator 42, a compressor 44, a condenser 46, and a throttling valve 47. The cooling system 40 is configured to remove heat from one location and discharge it into another location. A refrigerant is pumped through a cooling system 40.

A refrigerant vapor 48 at lower temperature and pressure is drawn to the compressor 44 and then compressed to a vapor 50 at a higher temperature and pressure. The refrigerant vapor 50 is condensed within the condenser 46 by transferring the heat from the warmer refrigerant vapor 50 to cooler air or water to generate a condensed refrigerant 52. The condensed refrigerant 52 is fed via the throttling valve 47 to the evaporator 42. The throttling valve 47 is configured to reduce the pressure of the condensed refrigerant 52 and generate the desired cooling effect on the vapor compression cycle. The refrigerant 52 evaporates (changes state) while passing through the evaporator 42. In the illustrated embodiment, the air 39 is fed in heat exchange relationship with the refrigerant 52 to cool the air 39 fed to the axial compressor 12. In the illustrated embodiment, an optional separator 54 is coupled to the cooling system 40 and the axial compressor 12 and configured to remove a condensate 55 from the cooled air 39 fed to the axial compressor 12.

In accordance with the illustrated embodiment, the cooling system 40 (mechanical chiller), using electric power, may be used regardless of the compressor architecture and intercooler configuration, to reduce the compressor duty and thereby enhance system efficiency. The exemplary cooling system 40 may be of interest especially when it is important to reduce the impact of changing ambient conditions on the operation of the axial compressor 12.

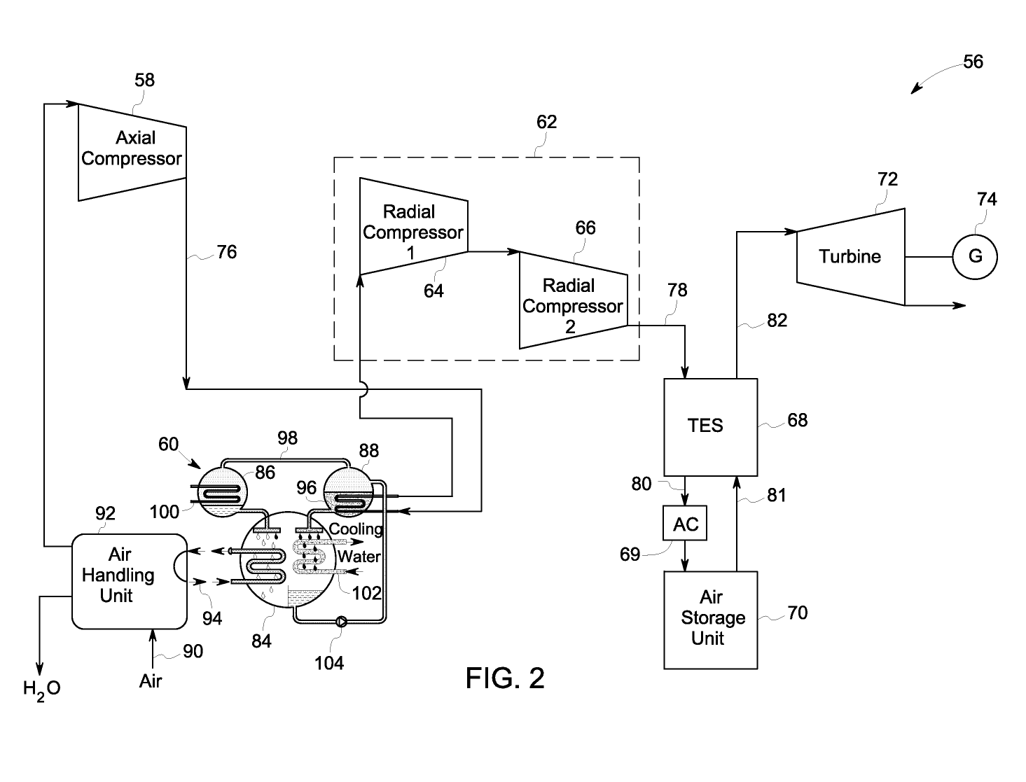

Referring to FIG. 2, a block diagram illustrating an energy storage system 56 is shown in accordance with another exemplary embodiment. The energy storage system 56 includes an axial compressor 58, a cooling system 60 coupled to the axial compressor 58, and a multi-stage radial compressor 62 including a first stage radial compressor 64 and a second stage radial compressor 66, coupled to the cooling system 60. Further, the energy storage system 56 includes a thermal energy storage unit 68 coupled to the multi-stage radial compressor 62 and an air storage unit 70, and a turbine 72 coupled to the thermal energy storage unit 68. Specifically, the thermal energy storage unit 68 is coupled to the air storage unit 70 via an after-cooler 69. A generator 74 is coupled to the turbine 72.

In the illustrated embodiment, a first compressed air 76 is fed from the axial compressor 58 to the multi-stage radial compressor 62 via the cooling system 60. A second compressed air 78 is fed from the multi-stage radial compressor 62 to the thermal energy storage unit 68. A thermal energy from the second compressed air 78 is retained within the thermal energy storage unit 68 for being used at a later stage. Thereafter, a cooled compressed air 80 is fed from the thermal energy storage unit 68 to the air storage unit 70 via the after-cooler 69. Depending on the requirement, a cooled compressed air 81 is fed from the air storage unit 70 to the thermal energy storage unit 68 to heat the cooled compressed air 81, using the stored thermal energy in the thermal energy storage unit 68. A heated compressed air 82 is fed from the thermal energy storage unit 68 to the turbine 72, to expand the heated compressed air 82 and generate an electric power via the generator 74.

In the illustrated embodiment, the cooling system 60 includes a vapor absorption cycle having a heat exchanger 84, a condenser 86, and a generation unit 88. Initially, air 90 enters an air handling unit 92 and is then cooled by a cooling loop 94 coupled to the air handling unit 92 and the heat exchanger 84. The cooling loop 94 may circulate chilled water or a glycol solution, for example, to cool the air 90 before being fed to the axial compressor 58. Additionally, moisture is also removed from the air 90.

The first compressed air 76 is fed from the axial compressor 58 to the multi-stage radial compressor 62 via the cooling system 60. The first compressed air 76 is cooled enroute to the first radial compressor 64 by exchanging heat with a liquid refrigerant 96 in the generation unit 88. In the illustrated embodiment, the generation unit 88 functions as an intercooler between the axial compressor 58 and the first stage radial compressor 64. The refrigerant 96 is boiled within the generation unit 88 to form a vapor 98 which is then fed to the condenser 86. In the illustrated embodiment, the generation unit 88 is referred to as a “heat source” and the first compressed air 76 is referred to as a “fluid”. The condenser 86 includes a heat exchanger 100 which outputs the liquid refrigerant 96 to cool the cooling loop 94 within the heat exchanger 84. The liquid refrigerant 96 is then cooled by a cooling loop 102 and pumped back by the pump 104 to the generation unit 88. Additionally, some portion of the liquid refrigerant 96 that remains in a liquid form from the generation unit 88, enters the heat exchanger 84, and is also cooled by the cooling loop 102 prior to being pumped back to the generation unit 88.

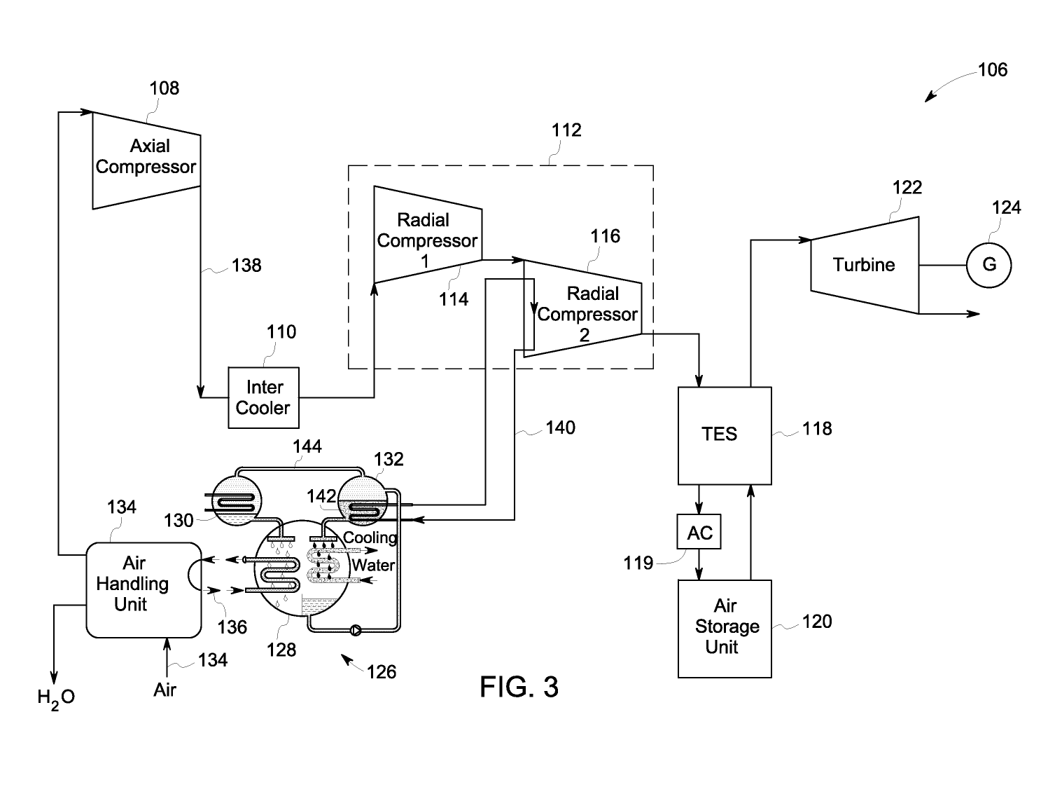

Referring to FIG. 3, a block diagram illustrating an energy storage system 106 is shown in accordance with another exemplary embodiment. The energy storage system 106 includes an axial compressor 108, an intercooler 110 coupled to the axial compressor 106, and a multi-stage radial compressor 112 including a first stage radial compressor 114 and a second stage radial compressor 116, coupled to the intercooler 110. Further, the energy storage system 106 includes a thermal energy storage unit 118 coupled to the multi-stage radial compressor 112 and an air storage unit 120, and a turbine 122 coupled to the thermal energy storage unit 118. Specifically, the thermal energy storage unit 118 is coupled to the air storage unit 120 via an after-cooler 119. A generator 124 is coupled to the turbine 122.

In the illustrated embodiment, the energy storage system 106 further includes a cooling system 126 having a vapor absorption cycle. The vapor absorption cycle includes a heat exchanger 128, a condenser 130, and a generation unit 132. Air 134 entering an air handling unit 134, is cooled by a cooling loop 136 coupled to the air handling unit 134 and the heat exchanger 128.

The functioning of the energy storage system 106 is similar to the functioning of the energy storage system 56 shown in FIG. 2. The difference being that in the illustrated embodiment, a first compressed air 138 is fed from the axial compressor 108 to the multi-stage radial compressor 62 via the intercooler 110. Additionally, a cooling medium 140 from the second stage radial compressor 116, is circulated in heat exchange relationship with a refrigerant 142 in the generation unit 132. The refrigerant 142 is boiled within the generation unit 132 to form a vapor 144 which is then fed to the condenser 130. In the illustrated embodiment, the second stage radial compressor 116 is referred to as a “heat source” and the cooling medium 140 is referred to as a “fluid”.

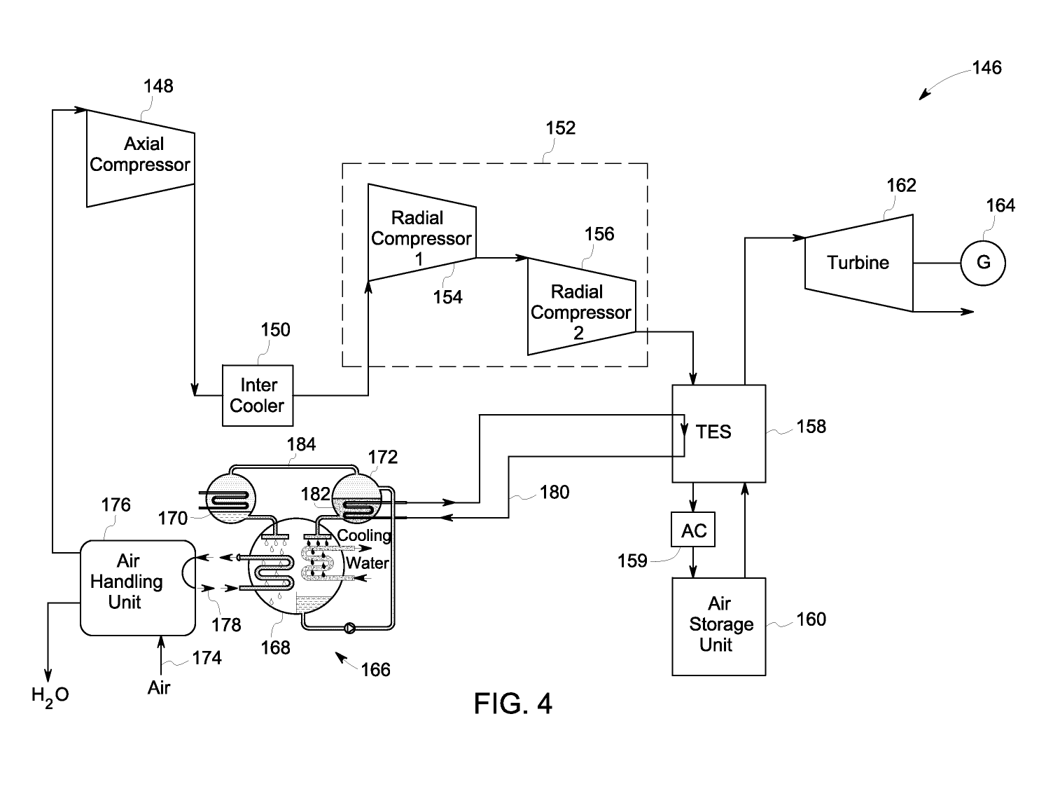

Referring to FIG. 4, a block diagram illustrating an energy storage system 146 is shown in accordance with another exemplary embodiment. The energy storage system 146 includes an axial compressor 148, an intercooler 150 coupled to the axial compressor 148, and a multi-stage radial compressor 152 including a first stage radial compressor 154 and a second stage radial compressor 156, coupled to the intercooler 150. Further, the energy storage system 146 includes a thermal energy storage unit 158 coupled to the multi-stage radial compressor 152 and an air storage unit 160, and a turbine 162 coupled to the thermal energy storage unit 158. Specifically, the thermal energy storage unit 158 is coupled to the air storage unit 160 via an after-cooler 159. A generator 164 is coupled to the turbine 162.

In the illustrated embodiment, the energy storage system 146 further includes a cooling system 166 having a vapor absorption cycle. The vapor absorption cycle includes a heat exchanger 168, a condenser 170, and a generation unit 172. Air 174 entering an air handling unit 176, is cooled by a cooling loop 178 coupled to the air handling unit 176 and the heat exchanger 168.

The functioning of the energy storage system 146 is similar to the functioning of the energy storage system 106 shown in FIG. 3. The difference being that in the illustrated embodiment, a cooling medium 180 from the thermal energy storage unit 158, is circulated in heat exchange relationship with a refrigerant 182 in the generation unit 172. In the illustrated embodiment, the thermal energy storage unit 158 is referred to as a “heat source” and the cooling medium 180 is referred to as a “fluid”. The refrigerant 182 is boiled within the generation unit 172 to form a vapor 184 which is then fed to the condenser 170.

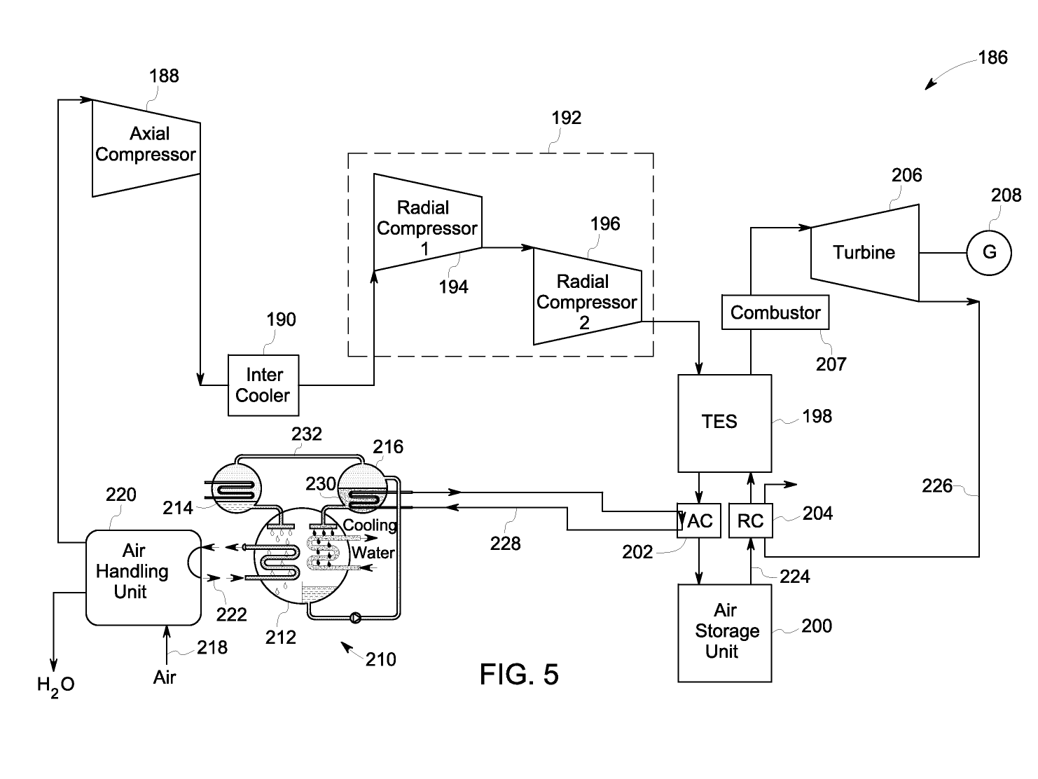

Referring to FIG. 5, a block diagram illustrating an energy storage system 186 is shown in accordance with another exemplary embodiment. The energy storage system 186 includes an axial compressor 188, an intercooler 190 coupled to the axial compressor 188, and a multi-stage radial compressor 192 including a first stage radial compressor 194 and a second stage radial compressor 196, coupled to the intercooler 190. Further, the energy storage system 186 includes a thermal energy storage unit 198 coupled to the multi-stage radial compressor 192. Further, the thermal energy storage unit 198 is coupled to an air storage unit 200 via a high pressure after-cooler 202 and an optional recuperator 204. A turbine 206 is coupled to the thermal energy storage unit 198, the recuperator 204, and a generator 208. Specifically, the turbine 206 is coupled to the thermal energy storage unit 198 via a combustor 207. In another embodiment, the recuperator 204 may not be used.

In the illustrated embodiment, the energy storage system 186 further includes a cooling system 210 having a vapor absorption cycle. The vapor absorption cycle includes a heat exchanger 212, a condenser 214, and a generation unit 216. Air 218 entering an air handling unit 220, is cooled by a cooling loop 222 coupled to the air handling unit 220 and the heat exchanger 212.

The functioning of the energy storage system 186 is similar to the functioning of the energy storage system 106 shown in FIG. 3. The difference being that in the illustrated embodiment, depending upon the requirement, a cooled compressed air 224 is fed from the air storage unit 200 to the thermal energy storage unit 198 via the recuperator 204. The cooled compressed air 224 is preheated by feeding an exhaust gas 226 from the turbine 206 in heat exchange relationship with the cooled compressed air 224 within the recuperator 204. The combustor 207 is used to heat preheated air fed from the thermal energy storage unit 198 to the turbine 206. Additionally, a cooling medium 228 from the high pressure after-cooler 202, is circulated in heat exchange relationship with a refrigerant 230 in the generation unit 216. In the illustrated embodiment, the high pressure after-cooler 202 is referred to as a “heat source” and the cooling air 228 is referred to as a “fluid”. The refrigerant 230 is boiled within the generation unit 216 to form a vapor 232 which is then fed to the condenser 214. In another embodiment, the cooled compressed air 224 is fed directly from the air storage unit 200 to the thermal energy storage unit 198.

In the illustrated embodiment, the size of the thermal energy storage unit 198 may be reduced to allow more recuperation of heat for the cooling system 210. The reduction in size of the thermal energy storage unit 198 is compensated by the recuperator 204, using the heat from the exhaust gas 226 from the turbine 206.

In accordance with the embodiments of FIGS. 2-5, a heat source selected from at least one of an intercooler, a second stage radial compressor, a thermal energy storage unit, and a high pressure after-cooler is used to drive a cooling system. While such heat in conventional systems is released to ambient air or a water cooling loop, in accordance with the embodiments of the present invention, such heat is used to power a cooling system. This means that inlet chilling in a CAES plant can take advantage of the compressor intercooling heat in a much more positive way than for standard gas turbines.

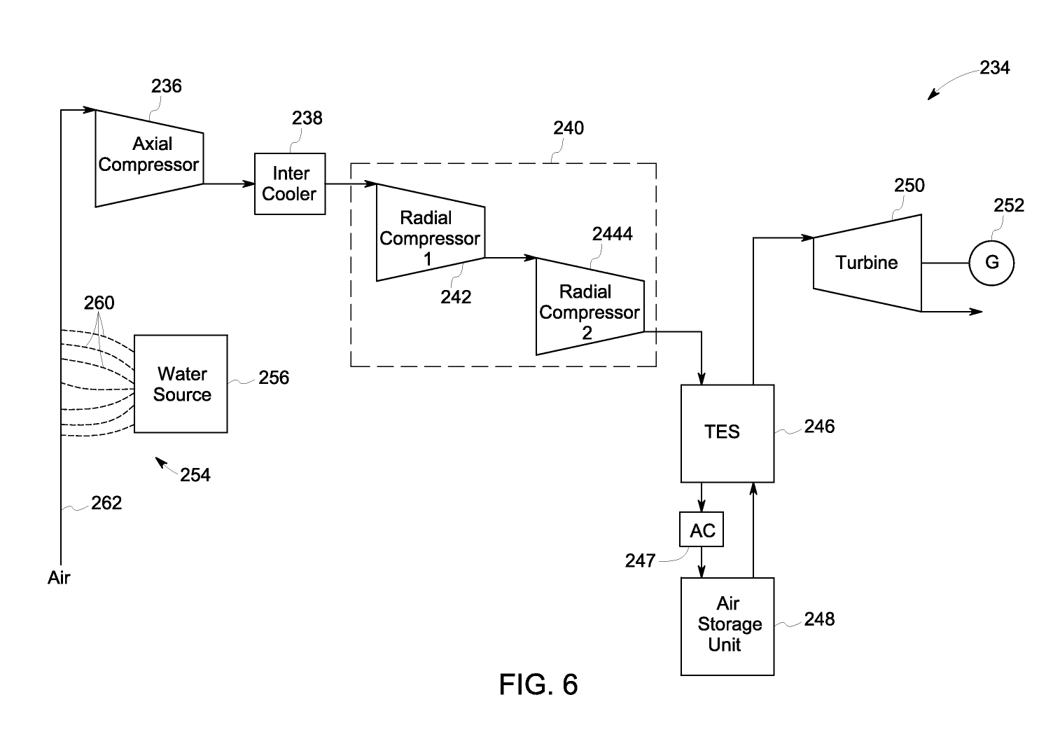

Referring to FIG. 6, a block diagram illustrating an energy storage system 234 is shown in accordance with another exemplary embodiment. The energy storage system 234 includes an axial compressor 236, an intercooler 238 coupled to the axial compressor 236, and a multi-stage radial compressor 240 including a first stage radial compressor 242 and a second stage radial compressor 244, coupled to the intercooler 238. Further, the energy storage system 234 includes a thermal energy storage unit 246 coupled to the multi-stage radial compressor 240 and an air storage unit 248, and a turbine 250 coupled to the thermal energy storage unit 246. Specifically, the thermal energy storage unit 246 is coupled to the air storage unit 248 via an after-cooler 247. A generator 252 is coupled to the turbine 250.

In the illustrated embodiment, the energy storage system 106 includes a cooling system 254. The cooling system 254 includes a water source 256 for spraying water 260 to cool air 262 fed to the axial compressor 236. The spraying of the water 260 reduces temperature at an inlet of the axial compressor 236 and during the compression process because evaporation of the water 260 absorbs heat from the air 262 during the compression, thereby decreasing the average temperature and power required for the entire compression process.

In accordance with the embodiments discussed herein, a compression power required during the charge phase of an energy storage system is reduced resulting in a higher round-trip efficiency. Variations in operating conditions of the compressor may be reduced by controlling a temperature of air entering the compressor train of the energy storage system. A higher average compressor efficiency caused by the chilling effect, reduces power consumption of the system. The number of compressor stages, types of compressors, and the number of thermal energy storage units may vary depending upon the application.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An energy storage system comprising:
an axial compressor;
an intercooler coupled to the axial compressor;
a multi-stage radial compressor comprising a first stage radial compressor and a second stage radial compressor, coupled to the intercooler;
a thermal energy storage unit coupled to the multi-stage radial compressor;
an air storage unit coupled to the thermal energy storage unit;
a turbine coupled to the thermal energy storage unit; and
a cooling system coupled to the axial compressor and configured to cool air fed to the axial compressor.

2. The energy storage system of claim 1, wherein the cooling system comprises a vapor compression cycle comprising an evaporator configured to feed the air in heat exchange relationship with a refrigerant to the cool the air fed to the axial compressor.

3. The energy storage system of claim 1, further comprising a separator coupled to the cooling system and the axial compressor and configured to remove a condensate from a cooled air fed to the axial compressor.

4. The energy storage system of claim 1, wherein the cooling system comprises a vapor absorption cycle comprising:
a heat exchanger configured to feed the air in heat exchange relationship with a refrigerant to the cool the air fed to the axial compressor; and
a heat source selected from at least one of the intercooler, the second stage radial compressor, the thermal energy storage unit, and an after-cooler coupled to the thermal energy storage unit and the air storage unit,
a generation unit coupled to the heat source and configured to feed a fluid from the heat source in heat exchange relationship with the refrigerant to boil the refrigerant.

5. The energy storage system of claim 4, wherein the heat source comprises the intercooler, wherein the fluid comprises compressed air fed from the axial compressor.

6. The energy storage system of claim 4, wherein the heat source comprises the second stage radial compressor, wherein the fluid comprises a cooling medium fed from the second stage radial compressor.

7. The energy storage system of claim 4, wherein the heat source comprises the thermal energy storage unit, wherein the fluid comprises a cooling medium fed from the thermal energy storage unit.

8. The energy storage system of claim 4, wherein the heat source comprises the after-cooler, wherein the fluid comprises a cooling medium fed from the after-cooler.

9. The energy storage system of claim 4, further comprising a recuperator coupled to the thermal energy storage unit, the air storage unit, and the turbine.

10. The energy storage system of claim 9, wherein the recuperator is configured to feed an exhaust gas from the turbine in heat exchange relationship with cooled compressed air fed from the air storage unit to the thermal energy storage unit to preheat the cooled compressed air.

11. The energy storage system of claim 1, wherein the cooling system further comprises a water source for spraying water to cool the air fed to the axial compressor.

12. A method for operating an energy storage system;
cooling air fed to an axial compressor via a cooling system;
feeding a first compressed air from the axial compressor to a multi-stage radial compressor comprising a first stage radial compressor and a second stage radial compressor, via an intercooler;
feeding a second compressed air from the multi-stage radial compressor to a thermal energy storage unit;
storing a thermal energy from the second compressed air in the thermal energy storage unit;
feeding a cooled compressed air from the thermal energy storage unit to an air storage unit;
feeding the cooled compressed air from the air storage unit to the thermal energy storage unit to heat the cooled compressed air using the stored thermal energy; and
feeding a heated compressed air from the thermal energy storage unit to a turbine to expand the heated compressed air and generate an electric power via a generator.

13. The method of claim 12, wherein feeding air via a cooling system comprises feeding the air in heat exchange relationship with a refrigerant via an evaporator of a vapor compression cycle to the cool the air fed to the axial compressor.

14. The method of claim 12, further comprising removing a condensate from a cooled air fed to the axial compressor via a separator.

15. The method of claim 12, wherein feeding air via a cooling system comprises feeding the air in heat exchange relationship with a refrigerant to the cool the air fed to the axial compressor and feeding a fluid from a heat source in heat exchange relationship with the refrigerant to boil the refrigerant; wherein the heat source is selected from at least one of the intercooler, the second stage radial compressor, the thermal energy storage unit, and an after-cooler coupled to the thermal energy storage unit and the air storage unit.

16. The method of claim 15, wherein the fluid comprises the first compressed air fed from the axial compressor and the heat source comprises the intercooler.

17. The method of claim 15, wherein the fluid comprises a cooling medium fed from the second stage radial compressor and the heat source comprises the second stage radial compressor.

18. The method of claim 15, wherein the fluid comprises a cooling medium fed from the thermal energy storage unit and the heat source comprises the thermal energy storage unit.

19. The method of claim 15, wherein the fluid comprises a cooling medium fed from the after-cooler and the heat source comprises the after-cooler.

20. The method of claim 12, further comprising preheating the cooled compressed air fed from the air storage unit to the thermal energy storage unit by feeding an exhaust gas from the turbine in heat exchange relationship with the cooled compressed air via a recuperator.

21. The method of claim 12, wherein cooling air comprises spraying water from a water source to cool the air fed to the axial compressor.
